(19) United States
(12) Patent Application Publication
(10) Pub. No.: US 2011/0067652 A1
(43) Pub. Date: Mar. 24, 2011

(54) DIESEL POWERED SEMI-TRAILER TRUCK

(76) Inventor: Alan Bishop, Naples, FL (US)

(21) Appl. No.: 12/759,088

(22) Filed: Apr. 13, 2010

Related U.S. Application Data
(60) Provisional application No. 61/168,683, filed on Apr. 13, 2009.

(51) Int. Cl. F02B 43/02; F02D 23/02

(52) U.S. Cl. 123/3; 477/32

(57) ABSTRACT

An improved vehicle having a hydrogen generator providing a mixture of hydrogen and/or oxygen to a combustion chamber of a diesel powered engine which is combined with diesel fuel for improving the efficiency of the diesel powered engine and substantially preventing unwanted organic residue produced by the combustion of the diesel fuel, a secondary cooling fan connected to the diesel powered engine; and a control system controlling the operation of at least one of the generator, the primary cooling fan and the secondary cooling fan to enhance the performance of the vehicle.

### CROSS-REFERENCE TO RELATED APPLICATION(S)

This application claims the benefit of U.S. Provisional Application Ser. No. 61/168,683 filed Apr. 13, 2009, entitled “DIESEL POWERED SEMI-TRAILER TRUCK,” which is hereby incorporated herein by reference in its entirety, including all references cited therein.

### BACKGROUND OF THE INVENTION

1. Field of the Invention

The present invention relates in general to an improved vehicle and, more particularly, but not by way of limitation, to an improved diesel powered semi-trailer truck having a secondary hydrogen fuel source and a secondary cooling fan cooperating together to improve the fuel efficiency of the improved semi-trailer truck.

2. Background Art

Diesel powered semi-trailer trucks are well known in the art. While diesel powered trucks are known in the art, they suffer from numerous drawbacks including, but not limited to, poor diesel engine performance caused by less than optimal fuel efficiency, the build up of carbon deposits within the combustion chamber of the diesel engine and unnecessary overuse and/or redundant use of certain engine components (e.g., the cooling fan). In general, a diesel powered truck comprises a glider kit in combination with a diesel powered engine. The glider kit includes a chassis with a cab, a plurality of wheels connected to a steering and braking system and optionally a plurality of other accessories. The diesel powered engine includes a primary fuel pump providing diesel fuel, a cooling system which includes a cooling fan and a radiator, and an exhaust system that carries away combustion gases produced by the diesel powered engine.

Because of the weight of the truck and the aforementioned deficiencies inherent in the operation of common diesel powered trucks, the overall fuel efficiency of such diesel powered trucks is substantially reduced.

Thus the need exists for an improved diesel powered truck that includes a secondary hydrogen fuel source providing hydrogen to the diesel engine and a secondary fan that can be operated in lieu of, or in concert with the primary cooling fan of the diesel engine to enhance the fuel efficiency of the same.

### SUMMARY OF THE INVENTION

In one embodiment, the present invention is directed to an improved vehicle, the improved vehicle comprising a semi-trailer truck glider kit in combination with a diesel powered engine, the diesel powered engine having a combustion chamber, a primary diesel fuel source and a primary cooling fan, the diesel engine being adapted to operate on a diesel fuel, hydrogen and air mixture received by the combustion chamber, the improvement comprising: (a) a hydrogen generator providing hydrogen to the combustion chamber of the diesel powered engine, the combustion chamber combining hydrogen and air with the diesel fuel for improving the efficiency of the diesel powered engine and substantially preventing unwanted organic residue produced by the combustion of the diesel fuel; (b) a secondary cooling fan connected to the diesel powered engine; and (c) a control system controlling the operation of at least one of the generator, the primary cooling fan and the secondary cooling fan to enhance the performance of the vehicle.

In another embodiment, the control system comprises a valve for delivering the hydrogen and air mixture at a selectively adjustable rate, the valve having a fuel inlet, a fuel outlet, and a fuel passage therebetween, wherein the fuel inlet is in fluid communication with the hydrogen generator and the fuel outlet is in fluid communication with the combustion chamber of the diesel powered engine.

In yet another embodiment, the improved vehicle further comprises an engine sensor in electrical communication with the control system and sensing at least one operating parameter of the diesel powered engine, and wherein the control system selectively permits the primary cooling fan and the secondary cooling fan to operate independently of one another responsive to the at least one parameter of the diesel powered engine.

In a preferred embodiment, the engine sensor continuously monitors the fuel efficiency of the diesel powered engine and causes the control system to increase the amount of hydrogen provided to the combustion chamber of the diesel powered engine when the diesel powered engine operates at a fuel efficiency of less than 25 miles per gallon.

In one embodiment, the engine sensor continuously monitors the operation of a turbocharger of the diesel powered engine to reduce the use of the same by modifying a gear ratio of a transmission of the diesel powered engine.

In another embodiment, the control system causes the hydrogen generator to deliver hydrogen to the combustion chamber at a selectively adjustable rate such that the diesel powered engine can be operated in excess of 30,000 miles without replacing at least one of an engine oil and an air filter of the diesel powered engine.

In yet another embodiment, the control system causes the hydrogen generator to deliver hydrogen to the combustion chamber at a selectively adjustable rate such that the diesel powered engine can be operated in excess of 30,000 miles without replacing both of an engine oil and an air filter of the diesel powered engine.

In another embodiment, the control system causes the primary cooling fan to cease operation and the secondary cooling fan to operate when the diesel powered engine is operated at ambient temperatures less than 30 degrees Fahrenheit.

In one embodiment the present invention is directed to an improved vehicle comprising a semi-trailer truck glider kit in combination with a diesel powered engine, the diesel powered engine having a combustion chamber, a primary diesel fuel source and a primary cooling fan, the diesel engine being adapted to operate on a diesel fuel, hydrogen and air mixture received by the combustion chamber, the improvement comprising: (a) a hydrogen generator providing a mixture of hydrogen and oxygen to the combustion chamber of the diesel powered engine, the combustion chamber receiving hydrogen, oxygen and air combined with the diesel fuel for improving the efficiency of the diesel powered engine and substantially preventing unwanted organic residue produced by the combustion of the diesel fuel; (b) a secondary cooling fan connected to the diesel powered engine; and (c) a control system controlling the operation of at least one of the hydrogen generator, the primary cooling fan and the secondary cooling fan to enhance the performance of the vehicle, wherein the control system comprises a valve for delivering a mixture of hydrogen and air at a selectively adjustable rate, the valve having a fuel inlet, a fuel outlet, and a fuel passage therebetween, wherein the fuel inlet is in fluid communication with the hydrogen generator and the fuel outlet is in fluid communication with the combustion chamber of the diesel powered engine.

In another embodiment, the improved vehicle comprises an engine sensor in electrical communication with the control system and sensing at least one operating parameter of the diesel powered engine, and wherein the control system selectively permits the primary cooling fan and the secondary cooling fan to operate independently of one another responsive to the at least one parameter of the diesel powered engine.

In yet another embodiment, the engine sensor continuously monitors the fuel efficiency of the diesel powered engine and causes the control system to increase the amount of hydrogen and air provided to the combustion chamber of the diesel powered engine when the diesel powered engine operates at a fuel efficiency of less than 25 miles per gallon.

In a preferred embodiment, the control system delivers a hydrogen and oxygen mixture to the combustion chamber at a selectively adjustable rate such that the diesel powered engine can be operated in excess of 30,000 miles without replacing at least one of an engine oil and an air filter of the diesel powered engine.

In another preferred embodiment, the control system causes the hydrogen generator to deliver hydrogen to the combustion chamber at a selectively adjustable rate such that the diesel powered engine can be operated in excess of 30,000 miles without replacing both of an engine oil and an air filter of the diesel powered engine.

In another embodiment, the control system causes the primary cooling fan to cease operation and the secondary cooling fan to operate when the diesel powered engine is operated at ambient temperatures less than 30 degrees Fahrenheit.

In another embodiment, the present invention is directed to an improved vehicle, the improved vehicle comprising a semi-trailer truck glider kit in combination with a diesel powered engine, the diesel powered engine having a combustion chamber, a primary diesel fuel source and a primary cooling fan, the diesel engine being adapted to operate on a diesel fuel, hydrogen and air mixture received by the combustion chamber, the improvement comprising: (a) a hydrogen generator providing a mixture of hydrogen and oxygen to the combustion chamber of the diesel powered engine, the combustion chamber receiving hydrogen, oxygen and air combined with the diesel fuel for improving the efficiency of the diesel powered engine and substantially preventing unwanted organic residue produced by the combustion of the diesel fuel; (b) a secondary cooling fan connected to the diesel powered engine; (c) a control system controlling the operation of at least one of the hydrogen generator, the primary cooling fan and the secondary cooling fan to enhance the performance of the vehicle; and (d) an engine sensor in electrical communication with the control system and sensing at least one operating parameter of the diesel powered engine, and wherein the control system selectively permits the primary cooling fan and the secondary cooling fan to operate independently of one another responsive to the at least one parameter of the diesel powered engine.

In another embodiment, the engine sensor continuously monitors the fuel efficiency of the diesel powered engine and causes the control system to increase the amount of hydrogen and oxygen provided to the combustion chamber of the diesel powered engine when the diesel powered engine operates at a fuel efficiency of less than 25 miles per gallon.

In a preferred embodiment, the control system delivers a hydrogen and oxygen mixture to the combustion chamber at a selectively adjustable rate such that the diesel powered engine can be operated in excess of 30,000 miles without replacing at least one of an engine oil and an air filter of the diesel powered engine.

In yet another embodiment, the control system causes the hydrogen generator to deliver hydrogen to the combustion chamber at a selectively adjustable rate such that the diesel powered engine can be operated in excess of 30,000 miles without replacing both of an engine oil and an air filter of the diesel powered engine.

In one embodiment, the control system causes the primary cooling fan to cease operation and the secondary cooling fan to operate when the diesel powered engine is operated at ambient temperatures less than 30 degrees Fahrenheit.

### BRIEF DESCRIPTION OF THE DRAWINGS

Certain embodiments of the present invention are illustrated by the accompanying FIGURE. It will be understood that the FIGURE is not necessarily to scale and that details not necessary for an understanding of the invention or that render other details difficult to perceive may be omitted. It will be understood that the invention is not necessarily limited to the particular embodiments illustrated herein.

The invention will now be described with reference to the drawing wherein:

FIG. 1 of the drawings is schematic representation of the improved semi-trailer truck, in accordance with the present invention.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

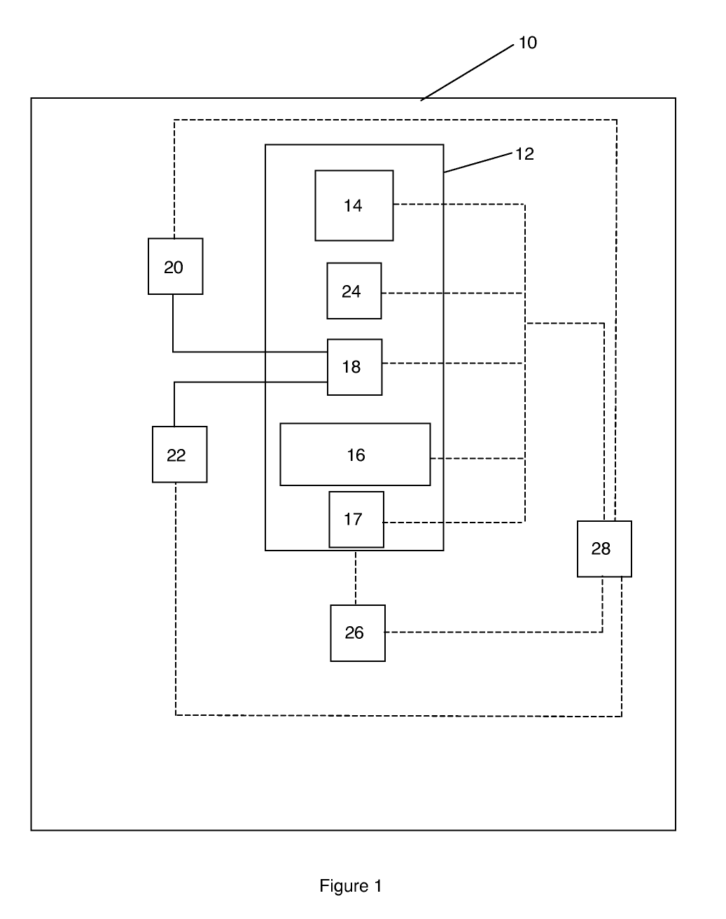

Referring now to FIG. 1, shown therein is a schematic representation of an improved semi-trailer truck 10 including a diesel engine 12. Although not shown, the improved semi-trailer truck 10 includes a semi-trailer truck glider kit that generally comprises all of the components of a semi-trailer truck less the power train, which in this case preferably comprises the diesel engine 12. As stated previously, the glider kit includes a cab, a chassis with a plurality of wheels rotatably connected to the chassis, a braking system, an exhaust system and other various accessories, for example, mirrors, lighting and the like. Therefore, the diesel engine 12, provided in combination with the glider kit comprises a standard, operational semi-trailer truck.

In one embodiment, the preferred diesel engine 12 selected for use in accordance with the present invention includes, for example, a Detroit Diesel Series 60 Recon Engine produced by the Detroit Diesel Corporation. It will be understood that other diesel engines 12 may be utilized so long as the diesel engine 12 utilized is capable of being adapted to operate on a mixture of diesel fuel and hydrogen fuel. Therefore, other diesel engines that would be known to one of ordinary skill in the art with the present disclosure before them are likewise contemplated for use in accordance with the present invention. The diesel engine 12 includes a cooling system comprising a primary cooling fan 14 operating in concert with a radiator (not shown) to transfer heat energy produced by the diesel engine 12 to improve the efficiency of the diesel engine 12, a transmission 16 connected to the diesel engine 12, a turbocharger 17 connected to the diesel engine 12, and a combustion chamber 18 (e.g., a plurality of cylinders of the engine) for mixing and delivering air, fuel and/or hydrogen for combustion in the diesel engine 12.

The semi-trailer truck 10 additionally includes a primary diesel fuel source, for example, a primary fuel pump 20 providing diesel fuel to the combustion chamber 18 of the diesel engine 12, a hydrogen generator 22 providing hydrogen and/or oxygen to the combustion chamber 18 of the diesel engine 12 and a secondary cooling fan 24.

In one embodiment, the preferred hydrogen generator 22 selected for use in accordance with the present invention includes, for example, a Jetstar™ produced by Dynamic Fuel Systems Incorporated. It will be understood that other hydrogen generators 22 may be utilized so long as the hydrogen generator 22 utilized is capable of being adapted to provide hydrogen and/or oxygen to the combustion chamber 18 of the diesel engine 12. Therefore, other hydrogen generators 22 that would be known to one of ordinary skill in the art with the present disclosure before them are likewise contemplated for use in accordance with the present invention.

In particular, the hydrogen generator 22 gasifies a hydrogen compatible fuel, for example, Jetfuel™ also produced by Dynamic Fuel Systems Incorporated, by separating the hydrogen and oxygen molecules contained within the fuel to produce hydrogen and oxygen gases. These gases are produced only while the diesel engine 12 is running and are produced under a slight pressure to ensure a consistent flow to the combustion chamber 18 of the diesel engine 12. The hydrogen generator 22 preferably draws only a small amount of power from the vehicle's electrical system (not shown) and therefore only negligibly affects fuel economy. With the addition of the hydrogen generator 22, the combustion process is preferably more efficient. More specifically, emissions such as nitrous oxides, hydrocarbons and carbon monoxide are substantially reduced both over time and distance. Also, the addition of a hydrogen and air mixture into the combustion chamber 18 allows the primary diesel fuel to burn within the diesel engine 12 more completely. Therefore, the hydrogen generator 22 may increase horsepower and, correspondingly, increase fuel mileage, resulting in lower maintenance and/or operating costs. For example, the inclusion of the hydrogen and air mixture may result in a substantially cleaner combustion chamber (not shown) relative to a diesel engine 12 without a hydrogen generator 22. By way of non-limiting example, the improved semi-trailer truck 10 may preferably operate in excess of 30,000 miles without need of changing the oil and/or the air filter utilized by the diesel engine 12.

An example of the hydrogen generator 22 along with details for installation and use of the same are discussed in at least the following reference, U.S. Patent Application Publication No. 2008/0047830, filed by Fairfull et al., the details of which are incorporated by reference herein in their entirety.

In one embodiment, the preferred secondary cooling fan 24 selected for use in accordance with the present invention includes, for example, an electric fan. It will be understood that other secondary cooling fans 24 may be utilized so long as the secondary cooling fan 24 utilized is capable of being operated in combination with the primary cooling fan 14 or in some cases, in lieu of the primary cooling fan 14 as will be discussed in greater detail infra. Therefore, other secondary cooling fans 24 that would be known to one of ordinary skill in the art with the present disclosure before them are likewise contemplated for use in accordance with the present invention.

The secondary cooling fan 24 is preferably a smaller sized fan (e.g., reduced electrical energy consumption) relative to the primary cooling fan 14. The secondary cooling fan 24 may be powered by, for example, an electrical current produced by the diesel engine 12 or other parts of the vehicle (e.g., an alternator or battery). The secondary cooling fan 24 is provided to work either concurrently or in lieu of the primary cooling fan 14. For example, when the diesel engine 12 of the semi-trailer truck 10 is operated under strenuous conditions such as driving uphill, the secondary cooling fan 24 works in concert with the primary cooling fan 14 to remove excess heat generated by the diesel engine 12. In contrast, when the diesel engine 12 is operated under lighter conditions, such as driving in the city on a cold day (e.g., temperatures lower than 30 degrees Fahrenheit), the diesel engine 12 produces less heat. Therefore, the primary cooling fan 14 is temporarily rendered inoperative such that the secondary cooling fan 24 is operating alone. As the secondary cooling fan 24 requires less electrical energy to operate than the primary cooling fan 14, the secondary cooling fan 24 allows the diesel engine 12 to operate more efficiently than the diesel engine 12 utilizing the primary cooling fan 14 exclusively.

Examples of secondary cooling fans are discussed in at least the following references, U.S. Pat. No. 4,677,941, issued to Kurz, and U.S. Pat. No. 4,409,933, issued to Inoue, the details of which are incorporated by reference herein in their entirety.

The semi-trailer truck 10 preferably includes an electrical sensor 26 in electrical communication with a control system 28. The electrical sensor 26 senses or monitors at least one operating parameter of the diesel engine 12, for example, speed, revolutions per minute, fuel consumption, engine temperature, ambient temperature, and/or combinations thereof. The electrical sensor 26 outputs data to the control system 28 for optimizing the fuel efficiency of the diesel engine 12 by controlling the operation of various components of the diesel engine 12. More specifically, the control system 28 is adapted to control the operation of at least the primary cooling fan 14, the secondary cooling fan 24, the primary fuel pump 20 and the hydrogen generator 22.

In one embodiment, the control system 28 includes a valve (not shown) for delivering hydrogen and/or oxygen from the hydrogen generator 22 at a selectively adjustable rate. By way of non-limiting example, the valve is preferably provided with a fuel inlet, a fuel outlet, and a fuel passage therebetween. The fuel inlet is in fluid communication with the hydrogen generator 22 and the fuel outlet is in fluid communication with the combustion chamber 18 of the diesel engine 12.

With respect to the primary and secondary cooling fans 14 and 24 respectively, when the electrical sensor 26 senses that the diesel engine 12 is operating under strenuous conditions such as driving uphill, the electrical sensor 26 communicates an electrical signal to the control system 28 which in turn communicates an electrical signal to the secondary cooling fan 24 to cause the secondary cooling fan 24 to operate in concert with the primary cooling fan 14 to remove excess heat generated by the diesel engine 12. In contrast, when the diesel engine 12 is operated under lighter conditions, such as driving in the city on a cold day (e.g., temperatures lower than 30 degrees Fahrenheit), the electrical sensor 26 communicates an electrical signal to the control system 28 which in turn communicates an electrical signal to the primary cooling fan 14 rendering it temporarily inoperative such that the secondary cooling fan 24 is operating alone.

With respect to the primary fuel pump 20 and the hydrogen generator 22, under typical operating conditions, for example, when the diesel engine 12 operates at a constant 1,800 revolutions per minute, the electrical sensor 26 communicates an electrical signal to the control system 28 which communicates with the hydrogen generator 22 to deliver a substantially constant amount of hydrogen and/or oxygen and a substantially constant amount of diesel fuel from the primary fuel source 20 to the combustion chamber 18 of the diesel engine 12. When the diesel engine 12 operates at higher revolution per minute, for example, when the semi-trailer truck 10 is operating on a hill, the electrical sensor 26 communicates an electrical signal to the control system 28 which communicates with the hydrogen generator 22 to deliver a greater amount of hydrogen and/or oxygen to the combustion chamber 18 of the diesel engine 12 than when the diesel engine 12 is operating at substantially constant rate of 1,800 revolutions per minute.

In one embodiment, the engine sensor 26 continuously monitors the fuel efficiency of the diesel engine 12 and causes the control system 28 to increase the amount of hydrogen and/or oxygen provided to the combustion chamber 18 by the hydrogen generator 22 when the diesel powered engine operates at a fuel efficiency of less than 25 miles per gallon. It will be understood that during any and all operation of the diesel engine 12, the control system 28 selectively controls the operation of both the primary fuel source 20 and the hydrogen generator 22 to maximize the fuel efficiency of the diesel engine 12.

In another embodiment, the engine sensor 26 continuously monitors the operation of a turbocharger 17 of the diesel engine 12 to reduce the use of the same by modifying a gear ratio of the transmission 16 of the diesel engine 12.

Additionally, it will be understood that typical semi-trailer trucks having diesel engines adapted to operate on a hydrogen enhanced fuel mixture may preferably be retrofit with a hydrogen generator 22, secondary cooling fan 24, electrical sensor 26 and control system 28 to produce an improved semi-trailer truck 10.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. An improved vehicle, the improved vehicle comprising a semi-trailer truck glider kit in combination with a diesel powered engine, the diesel powered engine having a combustion chamber, a primary diesel fuel source and a primary cooling fan, the diesel engine being adapted to operate on a diesel fuel, hydrogen and air mixture received by the combustion chamber, the improvement comprising:
a hydrogen generator providing hydrogen to the combustion chamber of the diesel powered engine, the combustion chamber receiving hydrogen and air combined with the diesel fuel for improving the efficiency of the diesel powered engine and substantially preventing unwanted organic residue produced by the combustion of the diesel fuel;
a secondary cooling fan connected to the diesel powered engine; and
a control system controlling the operation of at least one of the generator, the primary cooling fan and the secondary cooling fan to enhance the performance of the vehicle.

2. The improved vehicle according to claim 1, wherein the control system comprises a valve for delivering the hydrogen at a selectively adjustable rate, the valve having a fuel inlet, a fuel outlet, and a fuel passage therebetween, wherein the fuel inlet is in fluid communication with the hydrogen generator and the fuel outlet is in fluid communication with the combustion chamber of the diesel powered engine.

3. The improved vehicle according to claim 1, further comprising an engine sensor in electrical communication with the control system and sensing at least one operating parameter of the diesel powered engine, and wherein the control system selectively permits the primary cooling fan and the secondary cooling fan to operate independently of one another responsive to the at least one parameter of the diesel powered engine.

4. The improved vehicle according to claim 3, wherein the engine sensor continuously monitors the fuel efficiency of the diesel powered engine and causes the control system to increase the amount of hydrogen provided to the combustion chamber of the diesel powered engine when the diesel powered engine operates at a fuel efficiency of less than 25 miles per gallon.

5. The improved vehicle according to claim 3, wherein the engine sensor continuously monitors the operation of a turbocharger of the diesel powered engine to reduce the use of the same by modifying a gear ratio of a transmission of the diesel powered engine.

6. The improved vehicle according to claim 1, wherein the control system causes the hydrogen generator to deliver hydrogen to the combustion chamber at a selectively adjustable rate such that the diesel powered engine can be operated in excess of 30,000 miles without replacing at least one of an engine oil and an air filter of the diesel powered engine.

7. The improved vehicle according to claim 1 wherein the control system causes the hydrogen generator to deliver hydrogen to the combustion chamber at a selectively adjustable rate such that the diesel powered engine can be operated in excess of 30,000 miles without replacing both of an engine oil and an air filter of the diesel powered engine.

8. The improved vehicle according to claim 1, wherein the control system causes the primary cooling fan to cease operation and the secondary cooling fan to operate when the diesel powered engine is operated at ambient temperatures less than 30 degrees Fahrenheit.

9. An improved vehicle, the improved vehicle comprising a semi-trailer truck glider kit in combination with a diesel powered engine, the diesel powered engine having a combustion chamber, a primary diesel fuel source and a primary cooling fan, the diesel engine being adapted to operate on a diesel fuel, hydrogen, oxygen and air mixture received by the combustion chamber, the improvement comprising:
a hydrogen generator providing a mixture of hydrogen and oxygen to the combustion chamber of the diesel powered engine, the combustion chamber receiving hydrogen, oxygen and air combined with the diesel fuel for improving the efficiency of the diesel powered engine and substantially preventing unwanted organic residue produced by the combustion of the diesel fuel;
a secondary cooling fan connected to the diesel powered engine; and
a control system controlling the operation of at least one of the hydrogen generator, the primary cooling fan and the secondary cooling fan to enhance the performance of the vehicle, wherein the control system comprises a valve for delivering a mixture of hydrogen and air at a selectively adjustable rate, the valve having a fuel inlet, a fuel outlet, and a fuel passage therebetween, wherein the fuel inlet is in fluid communication with the hydrogen generator and the fuel outlet is in fluid communication with the combustion chamber of the diesel powered engine.

10. The improved vehicle according to claim 9, further comprising an engine sensor in electrical communication with the control system and sensing at least one operating parameter of the diesel powered engine, and wherein the control system selectively permits the primary cooling fan and the secondary cooling fan to operate independently of one another responsive to the at least one parameter of the diesel powered engine.

11. The improved vehicle according to claim 10, wherein the engine sensor continuously monitors the fuel efficiency of the diesel powered engine and causes the control system to increase the amount of hydrogen and oxygen provided to the combustion chamber of the diesel powered engine by the hydrogen generator when the diesel powered engine operates at a fuel efficiency of less than 25 miles per gallon.

12. The improved vehicle according to claim 9, wherein the control system causes the hydrogen generator to deliver hydrogen and oxygen to the combustion chamber at a selectively adjustable rate such that the diesel powered engine can be operated in excess of 30,000 miles without replacing at least one of an engine oil and an air filter of the diesel powered engine.

13. The improved vehicle according to claim 9, wherein the control system causes the hydrogen generator to deliver hydrogen and oxygen to the combustion chamber at a selectively adjustable rate such that the diesel powered engine can be operated in excess of 30,000 miles without replacing both of an engine oil and an air filter of the diesel powered engine.

14. The improved vehicle according to claim 9, wherein the control system causes the primary cooling fan to cease operation and the secondary cooling fan to operate when the diesel powered engine is operated at ambient temperatures less than 30 degrees Fahrenheit.

15. An improved vehicle, the improved vehicle comprising a semi-trailer truck glider kit in combination with a diesel powered engine, the diesel powered engine having a combustion chamber, a primary diesel fuel source and a primary cooling fan, the diesel engine being adapted to operate on a diesel fuel, hydrogen, oxygen and air mixture received by the combustion chamber, the improvement comprising:
a hydrogen generator providing a mixture of hydrogen and oxygen to the combustion chamber of the diesel powered engine, the combustion chamber receiving hydrogen, oxygen and air combined with the diesel fuel for improving the efficiency of the diesel powered engine and substantially preventing unwanted organic residue produced by the combustion of the diesel fuel;
a secondary cooling fan connected to the diesel powered engine;
a control system controlling the operation of at least one of the hydrogen generator, the primary cooling fan and the secondary cooling fan to enhance the performance of the vehicle; and
an engine sensor in electrical communication with the control system and sensing at least one operating parameter of the diesel powered engine.

16. The improved vehicle according to claim 15, wherein the engine sensor continuously monitors the fuel efficiency of the diesel powered engine and causes the control system to increase the amount of hydrogen and oxygen provided to the combustion chamber of the diesel powered engine by the hydrogen generator when the diesel powered engine operates at a fuel efficiency of less than 25 miles per gallon.

17. The improved vehicle according to claim 16, wherein the control system causes the hydrogen generator to deliver hydrogen and oxygen to the combustion chamber at a selectively adjustable rate such that the diesel powered engine can be operated in excess of 30,000 miles without replacing at least one of an engine oil and an air filter of the diesel powered engine.

18. The improved vehicle according to claim 15, wherein the control system causes the hydrogen generator to deliver hydrogen and oxygen to the combustion chamber at a selectively adjustable rate such that the diesel powered engine can be operated in excess of 30,000 miles without replacing both of an engine oil and an air filter of the diesel powered engine.

19. The improved vehicle according to claim 15, wherein the control system causes the primary cooling fan to cease operation and the secondary cooling fan to operate when the diesel powered engine is operated at ambient temperatures less than 30 degrees Fahrenheit.
